(19) United States
(12) Patent Application Publication
(10) Pub. No.: US 2020/0014777 A1
(43) Pub. Date: Jan. 9, 2020

(54) METHOD AND SYSTEM FOR CLOUD-BASED SOFTWARE APPLICATION EXECUTION WITH CONCURRENT SIGNALING

(71) Applicant: 10546658 CANADA INC., TORONTO (CA)

(72) Inventor: HEIKO ROTH, TORONTO (CA)

(21) Appl. No.: 16/029,008

(22) Filed: Jul. 6, 2018

(51) Int. Cl. H04L 29/08; H04L 29/06; H04L 12/58; G06F 9/54; G06F 11/30

(52) U.S. Cl. CPC H04L 67/34; H04L 67/42; H04L 51/046; G06F 11/3051; H04L 67/20; G06F 9/54; G06F 11/302; H04L 67/10

(57) ABSTRACT

A method and system of executing a software application in a client computing device coupled to a server computing device across a cloud computing platform. The method comprises transmitting, to a memory of the server computing device, a specification identifying a software application in conjunction with at least one expected result parameter and a threshold condition for the at least one expected result parameter, the at least one expected result parameter pertaining to execution of the software application in a processor of the client computing device, receiving, in the processor of the client computing device, a signaling automaton generated by the server computing device, the signaling automaton based at least partly on the at least one expected result parameter and the threshold condition, during concurrent execution, in the processor of the client computing device, of object code of the software application in conjunction with the signaling automaton, monitoring, by the signaling automaton, the at least one result parameter relative to the threshold condition, and signaling to at least one recipient communication device, by the signaling automaton during the concurrent execution, that the at least one result parameter is one of lower and higher in value than the threshold condition.

### TECHNICAL FIELD

The disclosure herein relates to execution of software applications in a production mode within a cloud platform computing system.

### BACKGROUND

Business enterprises reply on business software applications, of varying scope and complexity, to identify, assess and manage critical enterprise functions. An enterprise management software application solution that enables business organizations to monitor and receive alerts regarding changes in critical enterprise functions and attributes on a more timely and comprehensive basis results in lessened disruption, and proves less costly, to business entities.

### BRIEF DESCRIPTION OF THE DRAWINGS

FIG. 1 illustrates, in an example embodiment, a cloud-based system for software application execution with concurrent signaling.

FIG. 2 illustrates, in one example embodiment, an architecture of a a computing system for cloud-based software application execution with concurrent signaling.

FIG. 3 illustrates a method of operation, in one example embodiment, of a computing system for cloud-based software execution with concurrent signaling.

### DETAILED DESCRIPTION

Among other technical advantages and benefits, solutions provided herein provide a third-party software execution tool that, when selected and configured for concurrent execution with a third-party software application, continuously and constantly monitors results parameters produced during the concurrent execution and includes signaling capability to dispatch alerts pertaining to the monitored parameters in real-time. In particular, signaling automatons executed concurrently with execution of a software application in a production mode of operation, constantly and continuously monitor software execution results, including interim results produced during program execution pertaining to trends and aggregate data generated during software execution in real-time, or any results that deviate from an expectation based on previous norms, presence or absence of certain result values, and an expectation or confirmation as to whether various execution files or services exist and are functioning as intended. The signaling automatons may signal or report in real-time any anomalies in certain result parameters relative to expected result parameter values and expected trends in result parameters relative to certain threshold conditions. The signaling automatons may also monitor and signal an operational state relative to an expected operational state of the software application as the latter advances through program states of execution, thereby to indicate a state of health of the software application under execution. The signaling automaton solutions provided herein encapsulate specialized programming knowledge that is selectable, including for re-use, by users at customer or client computer systems in a cloud-based system for production execution of software applications, including enterprise software applications. In the production software execution environment, the signaling automatons advantageously minimize or eliminate a need for enterprise software application customers to apply specialized programming knowledge to develop real-time monitoring and signaling solutions, and instead select signaling automations, from a library of selections, to be configured in accordance with a specification of expected software execution result parameters and applicable threshold conditions.

In accordance with a first example embodiment, a method of executing a software application in a client computing device coupled to a server computing device across a cloud computing platform is provided. The method comprises transmitting, to a memory of the server computing device, a specification identifying a software application in conjunction with at least one expected result parameter and a threshold condition for the at least one expected result parameter, the at least one expected result parameter pertaining to execution of the software application in a processor of the client computing device, and receiving, in the processor of the client computing device, a signaling automaton generated by the server computing device, the signaling automaton based at least partly on the at least one expected result parameter and the threshold condition. During concurrent execution, in the processor of the client computing device, of object code of the software application in conjunction with the signaling automaton, monitoring, by the signaling automaton, the at least one result parameter relative to the threshold condition. Then signaling to at least one recipient communication device, by the signaling automaton during the concurrent execution, that the at least one result parameter is one of lower and higher in value than the threshold condition.

In one embodiment, the software application comprises an enterprise software business services application, and the specification further identifies version information of the enterprise software business services application.

In another embodiment, the signaling is independent of a communication generated by any one of the software application under execution and the client computing device.

In another variation, the at least one recipient communication device comprises at least one of (i) the client computing device, and (ii) a third-party recipient device that is not capable of directly addressing nor accessing the software application under execution.

In one embodiment, execution of the software application progressively advances through a series of stages predefined in source code of the software application, each stage of the series denoting one of an error-free and an error milestone result during executing one or more modules of the software application.

In an embodiment, the signaling automaton is defined by script code including data relating to the at least one expected result value and the threshold condition.

In another embodiment, the specification further incudes identification of at least one recipient communication device, the script code further includes data pertaining to the at least one recipient communication device, and further comprising signaling to the at least one recipient communication device.

In another variation, the monitoring comprises at least one application program interface (API) call to the software application during the concurrent execution.

In one embodiment, the signaling comprises at least one of an email communication and a text message communication.

In accordance with a second example embodiment, a non-transitory medium storing instructions executable in a processor of a computing device is provided. The instructions are executable to transmit, to a memory of a server computing device, a specification identifying a software application in conjunction with at least one expected result parameter and a threshold condition for the at least one expected result parameter, the at least one expected result parameter pertaining to execution of the software application in the processor of the computing device, receive, in the processor of the computing device, a signaling automaton generated by the server computing device, the signaling automaton based at least partly on the at least one expected result parameter and the threshold condition. Then, during concurrent execution, in the processor of the computing device, of object code of the software application in conjunction with the signaling automaton, monitor, by the signaling automaton, the at least one expected result parameter relative to the threshold condition, and signal to at least one recipient communication device, by the signaling automaton during the concurrent execution, that the at least one expected result parameter is one of lower and higher in value than the threshold condition.

In accordance with a third example embodiment, also provided is a client computing system including a client computing device having a processor and being coupled to a server computing device across a cloud computing platform. The client computing system comprises a memory storing a set of instructions. The instructions executable in the processor to transmit, to a memory of the server computing device, a specification identifying a software application in conjunction with at least one expected result parameter and a threshold condition for the at least one expected result parameter, the at least one expected result parameter pertaining to execution of the software application in the processor of the client computing device, and receive, in the processor of the client computing device, a signaling automaton generated by the server computing device, the signaling automaton based at least partly on the at least one expected result parameter and the threshold condition. Then, during concurrent execution, in the processor of the client computing device, of object code of the software application in conjunction with the signaling automaton, monitor, by the signaling automaton, the at least one expected result parameter relative to the threshold condition, and signal to at least one recipient communication device, by the signaling automaton during the concurrent execution, that the at least one expected result parameter is one of lower and higher in value than the threshold condition.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device.

Furthermore, one or more embodiments described herein may be implemented through the use of logic instructions that are executable by one or more processors of a computing device, including a server computing device. These instructions may be carried on a computer-readable medium. In particular, machines shown with embodiments herein include processor(s) and various forms of memory for storing data and instructions. Examples of computer-readable mediums and computer storage mediums include portable memory storage units, and flash memory (such as carried on smartphones). A server computing device as described herein utilizes processors, memory, and logic instructions stored on computer-readable medium. Embodiments described herein may be implemented in the form of computer processor-executable logic instructions or programs stored on computer memory mediums.

### System Description

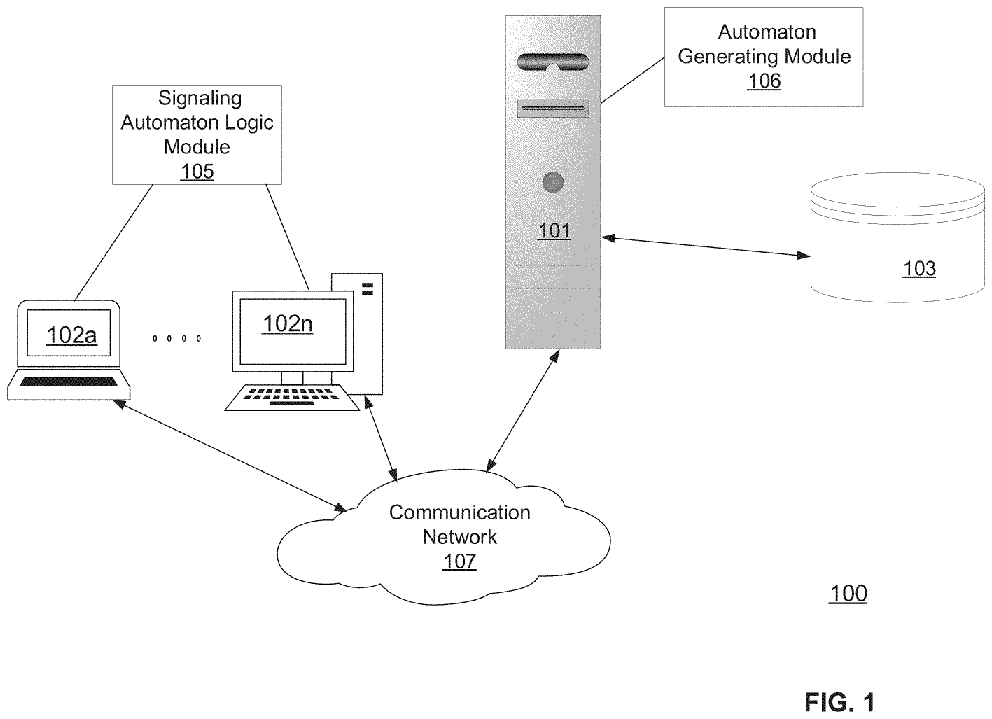

FIG. 1 illustrates, in an example embodiment, signaling automaton logic module 105 hosted at server computing device 101, within cloud networked system 100 for software application execution with concurrent signaling. While server computing device 101 may include automaton generating module 106 as depicted, it is contemplated that, in alternate embodiments, computing devices 102a-n, including desktop or laptop computers, in communication via network 107 with server 101, may include one or more sub-modules comprising automaton generating module 106, the latter embodied according to computer processor-executable instructions stored within a non-transitory memory. Database 103 may be communicatively accessible to server computing device 101 (also referred to as server 101 herein) and additionally, to one or more of client computing devices 102a-n via communication network 107.

Cloud-connected client computing devices 102a-n may be configured to include signaling automaton logic module 105. Customers of third-party software application programs (also referred to herein as software applications), including enterprise software applications, may execute such applications in a production mode at client computing devices 102a-n. The term production mode as used herein refers to operational usage in execution of the software application to fulfill functional and organizational duties or goals of the user, for example, an enterprise organization user of workforce management application software that includes payroll, time management, and budgeting functionality among other enterprise management features.

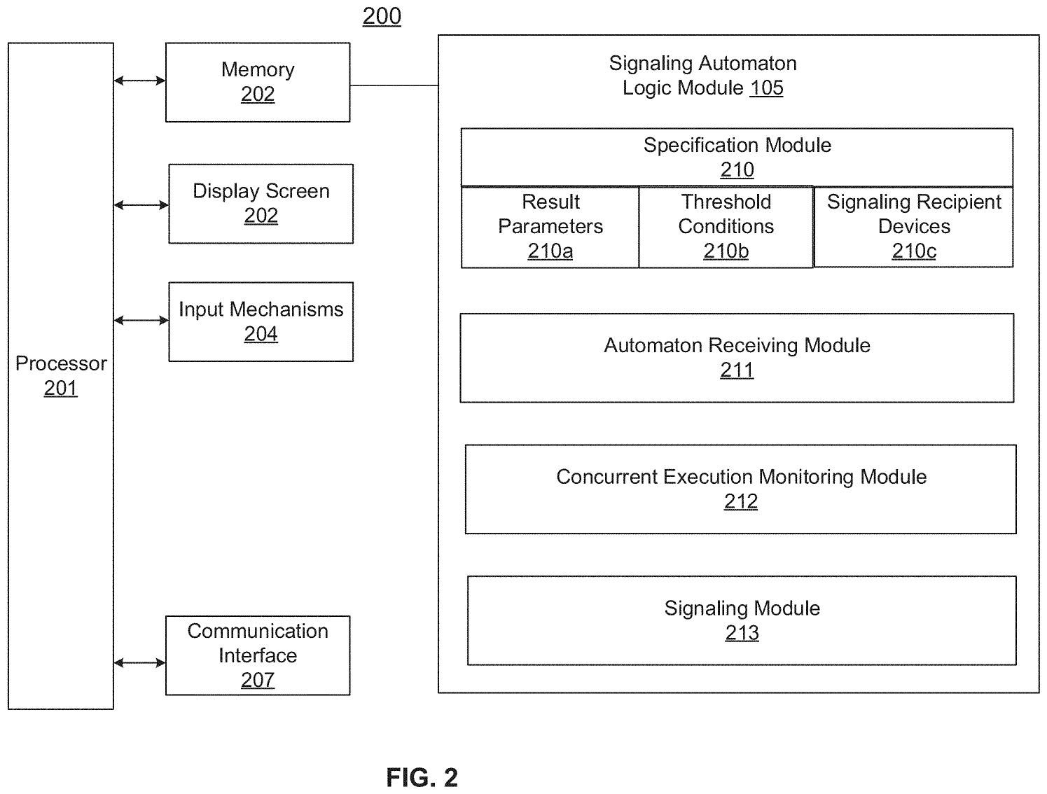

FIG. 2 illustrates architecture 200 of client computing device 102 hosting signaling automaton logic module 105, in an example embodiment. Client computing device 102 as used herein refers to any one of collective client computing devices 102a-n. Client computing device 102, which may be a desktop computer, a server computer or other computing system having similar functionality, may include processor 201, non-transitory memory 202 that includes signaling automaton logic module 105, display screen 203, input mechanisms 204 such as a keyboard or software-implemented touchscreen input functionality, and communication interface 207 for communicating via communication network 107.

Signaling automaton logic module 105 includes instructions stored in memory 202 of server 101, the instructions configured to be executable in processor 201. Signaling automaton logic module 105 may comprise portions or sub-modules including specification module 210, automaton receiving module 211, concurrent execution monitoring module 212 and signaling module 213.

Specification module 210 specification module 210 is used by a user at client computing device 102 to transmit, to a memory of server computing device 101, a specification identifying a software application for execution and at least one expected result parameter and a threshold condition for the at least one expected result parameter, the at least one expected result parameter being produced during execution of the software application in processor 201 of client computing device 102. In this particular embodiment, details constituting the specification may be compiled and provided by users via any one or more of cloud platform-based client computing devices 102a . . . 102n.

In one embodiment, the specification may include result parameters 210a, threshold conditions 210b and identification of signaling recipient devices 210c along in conjunction with addressing details for communication with signaling recipient devices 210c.

In one embodiment of an illustrative use case, where result parameter 210a may be a payroll amount for a given enterprise or store of $1500 per day, threshold condition 210b may be set at $500 in order to generate a signal or alert, in real-time, whenever the payroll amount for that given store on a given day is less than $500, thus notifying or alerting in real-time pre-identified recipient devices 210c of such unexpected or anomalous result during execution of a payroll enterprise software application in production mode.

In another illustrative use case, where result parameter 210a may be an expected number of employee clock punches for a given enterprise or store of 50 per day, threshold condition 210b may be set at 30 clock punches in order to generate a signal or alert, in real-time, whenever the number of employee clock punches for that given store on a given day is less than 30, thus notifying or alerting in real-time pre-identified recipient devices 210c of such unexpected or anomalous result during execution of an employee time management enterprise software application in production mode.

In yet another illustrative case in execution of the employee time management enterprise software application in production mode, where result parameter 210a may be a number of total employee overtime hours for the given store or enterprise, threshold condition 210c may be set to 1000 hours, in order to generate a signal or alert, in real-time, whenever the total employee overtime hours exceeds 1000, thus notifying or alerting in real-time pre-identified recipient devices 210c of the unexpected or anomalous result during the production run.

In another illustrative use case during a production run of enterprise budgeting and financial control software application, where result parameter 210a relates to an overall budget expenditure for the week, month or quarter, threshold condition 210b may be set at 105%, in order to generate a signal or alert, in real-time, whenever the total budget expenditures for the enterprise or business is 5% or higher than expected, notifying or alerting in real-time pre-identified recipient devices 210c that current budget expenditures have deviated from a predetermined or acceptable amount. In a variation, the threshold condition may be specified as a range of values outside of which constitutes unacceptable performance or results.

In one embodiment, the software application comprises an enterprise software business services application and the specification further identifies version information of the enterprise software business services application, and optionally a functional usage related to a functional group of an enterprise organization.

Automaton receiving module 211 receives, in memory of client computing device 102, a signaling automaton generated by automaton generating module 106 of server computing device 101, the signaling automaton based at least partly on one or more expected result parameters in conjunction with respective threshold conditions.

The signaling automaton as generated at server computing device 101 using automaton generating module 106, in an embodiment, is defined by programmable script code including data relating to the at least one expected result value and the threshold condition. Optionally, a source internet protocol (IP) address identifying server computing device 101 as a source wherein the signaling automaton has been generated may be included in the script code. In one variation, where the specification as created or drafted at client computing device 101 further incudes identification and communication addressing details of third-party recipient communication devices 310c, the script code of the signaling automaton may further encode data pertaining to the third-party recipient communication devices 310c, such that the signaling may be further directed to the recipient communication devices 310c. In another variation, the signaling automaton as constituted or embodied of scripting code may be enabled for application program interface (API) calls to the enterprise software application during concurrent execution therewith at client computing device 102. The scripting code of the signaling automaton may include data relating to the expected result values along with their respective threshold conditions as specified via specification module 210, in some embodiments. Yet further, data embodied in the scripting code constituting the signaling automaton may include authentication data to provide secure accessing of client computing device 102, for instance the internet protocol (IP) address that identifies 101 server computing device as a source device from where it is generated or created.

The signaling automaton, in another embodiment, may be selected by a user at client computing device 102 from a library of signaling automatons stored in a memory of database 103 communicatively coupled to server device 101 Such a basic building block automaton, or automaton in a fundamental state, may then be configured, modified or customized at client computing device 102 in accordance with the specification including expected result parameters 210a and any threshold conditions 210b for the expected result parameters, prior to being deployed for concurrent execution with the software application. The specification may further include communication addressing details of additional signaling recipient communication devices 210c to which signaling module 213 may direct communications from the signaling automaton during the concurrent execution. In one embodiment, a user at client computing device 102 selects the signaling automaton generated at server computing device 101 based on a given software application or software application version, the specification of at least an expected result parameter and related threshold conditions, whereupon the signaling automaton is received into memory 202 of client computing device 102.

Once generated at server computing device 101, the signaling automaton may be stored in a memory of a database, such as database 103 communicatively accessible to server 101, and made available to users at client computing devices 102a-n for re-use in conjunction with execution of various third-party software application products in production mode, in one embodiment. The signaling automaton, in such an embodiment, provides customizable ‘building blocks’ for production execution or software application products, including enterprise software application products based on requirements specified or defined by users of computing devices 102a-n, advantageously eliminating or minimizing the development cost, lead time, and effort in deploying the signaling automatons for concurrent execution with software applications in a production mode.

Concurrent execution monitoring module 212 monitors, during the concurrent execution of object code of the software application in conjunction with the signaling automaton, the result parameters relative to their respective threshold condition conditions as specified in accordance with specification module 210.

The signaling automaton may use access methods to access execution states, interim execution results, as well as final output execution results for the software application under execution. For example, in one embodiment, the signaling automaton may access one or more results during execution of software application using one or more application program interface (API) calls during the concurrent execution.

Signaling module 213 enables signaling to at least one recipient communication device, by the signaling automaton during the concurrent execution, that the at least one result parameter is lower and higher in value than the threshold condition or represents a trend that is outside of an acceptable range of values. It is contemplated, more broadly, that signaling automatons described herein may monitor software program execution results pertaining to trends and aggregate data generated from interim or final software execution results in real-time, or any result that deviates from an expectation based on previous norms, presence or absence of certain result values, and an expectation or confirmation as to whether various execution files or services exist and are functioning as intended. In another example embodiment, signaling automations, in conjunction with algorithms employing statistical analysis, can alert for results, or lack of certain results, that tend to indicate fraudulent activity.

The signaling automaton generates a communication or alert to notify one or more recipient communication devices 210c as specified in accordance with specification module 210 and automaton receiving module 211 that an important or unusual event has occurred, such as when a results parameter value is out of control or unexpected relative to the predetermined or pre-established threshold condition. In one embodiment, recipient communication devices 210c may be third-party recipient communication devices that are not be enabled for directly addressing nor accessing the software application under execution at client computing device 102. In one embodiment, the communication is constituted in the form of an e-mail message or an SMS instant message. Recipient communication devices 210c may be selected, for example, the client system or customer's information technology support group or a vendor of the third-party enterprise software application, to receive alerts or notifications in accordance with the signaling. In general, the signaling automations provided herein make more certain that parties or entities tasked with maintaining a certain standard of functioning of the business enterprise the system are aware, in real-time, of a change in business circumstance as indicated by the production software program execution.

In some embodiments, if one or more recipient communication devices detect or confirm the event is important by virtue of the signaling alert being acted upon quickly, for instance that a remedial action in response to the signaling communication or notification has been undertaken or fulfilled, the signaling automaton may also employ or embody a self-learning, machine learning, or other artificial intelligence attribute or feature to increase a probabilistic weighting accorded such event, whereupon such events accorded the higher weighting may receive, or be assigned, a higher priority for signaling in accordance with functionality of signaling module 213.

In one embodiment, the signaling is independent of a communication generated by at least one of (i) the software application under execution, and (ii) the client computing device. The signaling, to server computing device 101, and optionally to additional recipient communication devices if preidentified or pre-set as such, in one embodiment may be accomplished using any one or more of an email and a text messaging format. It is contemplated, however, that alternate or additional communication formats, including but not limited to a social media platform alert or notification, may be utilized.

In another embodiment, the signaling is further directed to at least one of (i) a recipient communication device not capable of directly addressing the client computing device, and (ii) a recipient communication device not capable of accessing the software application under execution.

In one variation, where the specification further incudes identification of a third-party recipient communication device, the script code of the signaling automaton may further encode data pertaining to the third-party recipient communication device, such that the signaling may be directed or communicated, for instance via an email message or a text message, to the third-party recipient communication device.

In some variations, execution of the software application progressively advances through a series of stages predefined in source code of the software application to confirm an error-free execution milestone status or an error-encountered status during executing one or modules of the software application. The signaling in the latter embodiment may communicate an error message attributable to a defect or configuration error in the one or more modules during execution of the software application. Such defect or configuration error may be indicative of an error condition generated at one or more program milestone markers or portions of the software application during execution of the software application, and may be used to check, and indicate or represent, a general fitness-for-the-purpose condition of the software application, or a particular version of the software application

### Methodology

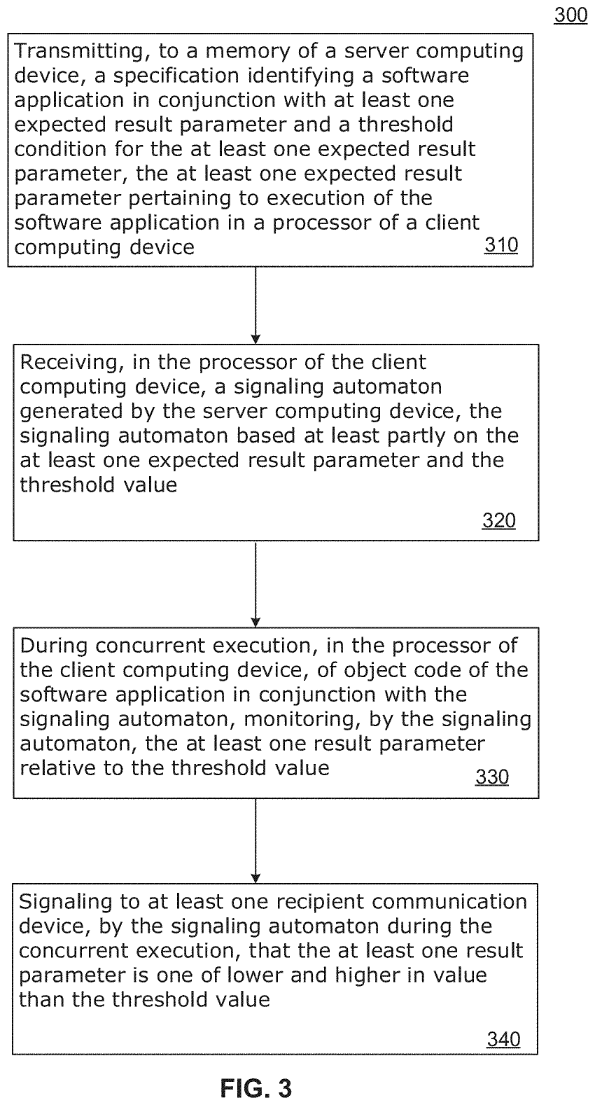

FIG. 3 illustrates, in an example embodiment, method 300 of deploying concurrent execution of a software applications in conjunction with one or more signaling automatons using client computing device 102 across a cloud computing platform, method 300 being performed by one or more processors 201 of client computing device 102. In describing the example of FIG. 3, reference is made to the examples of FIG. 1 and FIG. 2 for purposes of illustrating suitable components or elements for performing a step or sub-step being described.

Examples of method steps described herein relate to the use of client computing device 102 including signaling automaton logic module 105 for implementing the techniques described. According to one embodiment, the techniques are performed by client computing device 102 in response to the processor 201 executing one or more sequences of software logic instructions that constitute signaling automaton logic module 105. In embodiments, signaling automaton logic module 105 may include the one or more sequences of instructions within sub-modules including specification module 210, automaton receiving module 211, concurrent execution monitoring module 212 and signaling module 213. Such instructions may be read into memory 202 from machine-readable medium, such as memory storage devices. In executing the sequences of instructions contained in specification module 210, automaton receiving module 211, concurrent execution monitoring module 212 and signaling module 213 of signaling automaton logic module 105 in memory 202, processor 201 performs the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions. Additionally, it is also contemplated that in alternative embodiments, the techniques herein, or portions thereof, may be distributed between the computing devices 102a-n and server computing device 101. For example, computing devices 102a-n may perform some portion of functionality described herein with regard to various modules of which signaling automaton logic module 105 is comprised, and transmit data to server 101 that, in turn, performs at least some portion of the techniques described herein.

At step 310, processor 201 executes instructions of specification module 210 to transmit, to a memory of server computing device 101, a specification identifying a software application for execution and at least one expected result parameter and a threshold condition for the at least one expected result parameter, the at least one expected result parameter being produced during execution of the software application in processor 201 of client computing device 102. In this particular embodiment, details constituting the specification may be compiled and provided by users via any one or more of cloud platform-based client computing devices 102a . . . 102n.

In one embodiment, the specification may include result parameters 210a, threshold conditions 210b and identification of signaling recipient devices 210c along in conjunction with addressing details for communication with signaling recipient devices 210c.

In one embodiment of an illustrative use case, where the expected result parameter may be a payroll amount for a given enterprise or store of $1500 per day, the threshold condition may be set at $500 in order to generate a signal or alert, in real-time, whenever the payroll amount for that given store on a given day is less than $500, thus notifying or alerting in real-time pre-identified recipient devices 210c of such unexpected or anomalous result during execution of a payroll enterprise software application in production mode.

In another illustrative use case, where the expected result parameter may be an expected number of employee clock punches for a given enterprise or store of 50 per day, the threshold condition may be set at 30 clock punches in order to generate a signal or alert, in real-time, whenever the number of employee clock punches for that given store on a given day is less than 30, thus notifying or alerting in real-time pre-identified recipient devices 210c of such unexpected or anomalous result during execution of an employee time management enterprise software application in production mode.

In yet another illustrative case in execution of the employee time management enterprise software application in production mode, where the expected result parameter my be a number of total employee overtime hours for the given store or enterprise, the threshold condition may be set to 1000 hours, in order to generate a signal or alert, in real-time, whenever the total employee overtime hours exceeds 1000, thus notifying or alerting in real-time pre-identified recipient devices 210c of the unexpected or anomalous result during the production run.

In another illustrative use case during a production run of enterprise budgeting and financial control software application, where the expected result relates to an overall budget expenditure for the current day, week, month or quarter, the threshold condition may be set at 105%, in order to generate a signal or alert, in real-time, whenever the total budget expenditures for the enterprise or business is 5% or higher than expected, notifying or alerting in real-time pre-identified recipient devices 210c that current budget expenditures have deviated from a predetermined or acceptable amount. In a variation, the threshold condition may be specified as a range of values outside of which constitutes unacceptable performance or results.

In one embodiment, the software application comprises an enterprise software business services application, and the specification further identifies version information of the enterprise software business services application, and optionally a functional usage related to a functional group of an enterprise organization.

At step 320, processor 201 of server computing device 101 executes instructions included in automaton receiving module 211 to receive, in the processor of the client computing device, a signaling automaton generated by automaton generating module 106 of server computing device 101, the signaling automaton based at least partly on one or more expected result parameters in conjunction with respective threshold conditions.

The signaling automaton as generated at server computing device 101 using automaton generating module 106, in an embodiment, is defined by programmable script code including data relating to the at least one expected result value and the threshold condition. Optionally, a source internet protocol (IP) address identifying server computing device 101 as a source wherein the signaling automaton has been generated may be included in the script code. In one variation, where the specification as created or drafted at client computing device 101 further incudes identification and communication addressing details of third-party recipient communication devices 310c, the script code of the signaling automaton may further encode data pertaining to the third-party recipient communication devices 310c, such that the signaling may be further directed to the recipient communication devices 310c. In another variation, the signaling automaton as constituted or embodied of scripting code may be enabled for application program interface (API) calls to the enterprise software application during concurrent execution therewith at client computing device 102. The scripting code of the signaling automaton may include data relating to the expected result values along with their respective threshold conditions as specified via specification module 210, in some embodiments. Yet further, data embodied in the scripting code constituting the signaling automaton may include authentication data to provide secure accessing of client computing device 102, for instance the internet protocol (IP) address that identifies 101 server computing device as a source device from where it is generated or created.

The signaling automaton, in another embodiment, may be selected by a user at client computing device 102 from a library of signaling automatons stored in a memory of database 103 communicatively coupled to server device 101 Such a basic building block automaton, or automaton in a fundamental state, may then be configured, modified or customized at client computing device 102 in accordance with the specification including expected result parameters 210a and any threshold conditions 210b for the expected result parameters, prior to being deployed for concurrent execution with the software application. The specification may further include communication addressing details of additional signaling recipient communication devices 210c to which signaling module 213 may direct communications from the signaling automaton during the concurrent execution. In one embodiment, a user at client computing device 102 selects the signaling automaton generated at server computing device 101 based on a given software application or software application version, the specification of at least an expected result parameter and related threshold conditions, whereupon the signaling automaton is received into memory 202 of client computing device 102.

Once generated at server computing device 101, the signaling automaton may be stored in a memory of a database, such as database 103 communicatively accessible to server 101, and made available to users at client computing devices 102a-n for re-use in conjunction with execution of various third-party software application products in production mode, in one embodiment. The signaling automaton, in such an embodiment, provides customizable ‘building blocks’ for production execution or software application products, including enterprise software application products based on requirements specified or defined by users of computing devices 102a-n, advantageously eliminating or minimizing the development cost, lead time, and effort in deploying the signaling automatons for concurrent execution with software applications in a production mode.

At step 330, processor 201 executes instructions included in concurrent execution monitoring module 212, to monitor, during the concurrent execution of object code of the software application in conjunction with the signaling automaton, the result parameters relative to their respective threshold condition conditions as specified using specification module 210.

The signaling automaton may use access methods to access execution states, interim execution results, as well as final output execution results for the software application under execution. For example, in one embodiment, the signaling automaton may access one or more results during execution of software application using one or more application program interface (API) calls during the concurrent execution.

At step 340, processor 201 executes instructions included in signaling module 212, signaling to at least one recipient communication device, by the signaling automaton during the concurrent execution, that the at least one result parameter is one of lower and higher in value than the threshold condition, or outside of an acceptable range.

The signaling automaton generates a communication or alert to notify one or more recipient communication devices 210c as specified in accordance with specification module 210 and automaton receiving module 211 that an important or unusual event has occurred, such as when a results parameter value is out of control or unexpected relative to the predetermined or pre-established threshold condition. In one embodiment, recipient communication devices 210c may be third-party recipient communication devices that are not be enabled for directly addressing nor accessing the software application under execution at client computing device 102. In one embodiment, the communication is constituted in the form of an e-mail message or an SMS instant message. Recipient communication devices 210c may be selected, for example, the client system or customer's information technology support group or a vendor of the third-party enterprise software application, to receive alerts or notifications in accordance with the signaling.

As described herein, individual ones of client computing devices 102a-n are collectively referred to as client computing device 102. Recipient communication devices 210c may be specified, at specification module 210, as client computing device 102, or a user at server device 101 in alternate embodiments. If one or more recipient communication devices detect or confirm the event is important by virtue of the signaling alert being acted upon quickly, for instance that a remedial action in response to the signaling communication or notification has been undertaken or fulfilled, the signaling automaton may also employ or embody a self-learning or artificial intelligence attribute to increase a probabilistic weighting accorded such event, whereupon such events accorded the higher weighting may receive, or be assigned, a higher priority for signaling in accordance with functionality of signaling module 213.

In one embodiment, the signaling is independent of a communication generated by at least one of (i) the software application under execution, and (ii) the client computing device. The signaling, to server computing device 101, and optionally to additional recipient communication devices if preidentified or pre-set as such, in one embodiment may be accomplished using any one or more of an email and a text messaging format. It is contemplated, however, that alternate or additional communication formats, including but not limited to a social media platform alert or notification, may be utilized.

In another embodiment, the signaling is further directed to at least one of (i) a recipient communication device not capable of directly addressing the client computing device, and (ii) a recipient communication device not capable of accessing the software application under execution.

In one variation, where the specification further incudes identification of a third-party recipient communication device, the script code of the signaling automaton may further encode data pertaining to the third-party recipient communication device, such that the signaling may be directed or communicated, for instance via an email message or a text message, to the third-party recipient communication device.

In some variations, execution of the software application progressively advances through a series of stages predefined in source code of the software application to confirm an error-free execution milestone status or an error-encountered status during executing one or modules of the software application. The signaling in the latter case may communicate an error message attributable to a defect or configuration error in the one or more modules during execution of the software application. The defect or configuration error may be indicative of an error condition generated at one or more program milestone markers or portions of the software application during execution of the software application, and may be used to check, and indicate or represent, a general fitness-for-the-purpose condition of the software application, or a particular version of the software application.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventors from claiming rights to such combinations.

What is claimed is:

1. A method of executing a software application in a client computing device coupled to a server computing device across a cloud computing platform, the method comprising:
transmitting, to a memory of the server computing device, a specification identifying a software application in conjunction with at least one expected result parameter and a threshold condition for the at least one expected result parameter, the at least one expected result parameter pertaining to execution of the software application in a processor of the client computing device;
receiving, in the processor of the client computing device, a signaling automaton generated by the server computing device, the signaling automaton based at least partly on the at least one expected result parameter and the threshold condition;
during concurrent execution, in the processor of the client computing device, of object code of the software application in conjunction with the signaling automaton, monitoring, by the signaling automaton, the at least one result parameter relative to the threshold condition; and
signaling, to at least one recipient communication device, by the signaling automaton during the concurrent execution, that the at least one result parameter is one of lower and higher in value than the threshold condition.

2. The method of claim 1 wherein the software application comprises an enterprise software business services application, and the specification further identifies version information of the enterprise software business services application.

3. The method of claim 1 wherein the signaling is independent of a communication generated by at least one of (i) the software application under execution, and (ii) the client computing device.

4. The method of claim 1 wherein the at least one recipient communication device comprises at least one of (i) the client computing device, and (ii) a third-party recipient device that is not capable of directly addressing nor accessing the software application under execution.

5. The method of claim 1 wherein execution of the software application progressively advances through a series of stages predefined in source code of the software application, each stage of the series denoting one of an error-free and an error milestone result during executing one or more modules of the software application.

6. The method of claim 1 wherein the signaling automaton is defined by script code including data relating to the at least one expected result value and the threshold condition.

7. The method of claim 6 wherein the specification further incudes identification of at least one recipient communication device, the script code further includes data pertaining to the at least one recipient communication device, and further comprising signaling to the at least one recipient communication device.

8. The method of claim 1 wherein the monitoring comprises at least one application program interface (API) call to the software application during the concurrent execution.

9. The method of claim 1 wherein the signaling comprises at least one of an email communication and a text message communication.

10. A client computing system, the client computing system including a client computing device having a processor and coupled to a server computing device across a cloud computing platform, the client computing system comprising:
a memory storing a set of instructions, the instructions executable in the processor to:
transmit, to a memory of the server computing device, a specification identifying a software application in conjunction with at least one expected result parameter and a threshold condition for the at least one expected result parameter, the at least one expected result parameter pertaining to execution of the software application in the processor of the client computing device;
receive, in the processor of the client computing device, a signaling automaton generated by the server computing device, the signaling automaton based at least partly on the at least one expected result parameter and the threshold condition;
during concurrent execution, in the processor of the client computing device, of object code of the software application in conjunction with the signaling automaton, monitor, by the signaling automaton, the at least one expected result parameter relative to the threshold condition; and
signal, to at least one recipient communication device, by the signaling automaton during the concurrent execution, that the at least one expected result parameter is one of lower and higher in value than the threshold condition.

11. The client computing system of claim 10 wherein the software application comprises an enterprise software business services application, and the specification further identifies version information of the enterprise software business services application.

12. The client computing system of claim 10 wherein the signaling is independent of a communication generated by at least one of (i) the software application under execution, and (ii) the client computing device.

13. The client computing system of claim 10 wherein the at least one recipient communication device comprises at least one of (i) the client computing device, and (ii) a third-party recipient device that is not capable of directly addressing nor accessing the software application under execution.

14. The client computing system of claim 10 wherein execution of the software application progressively advances through a series of stages predefined in source code of the software application, each stage of the series denoting one of an error-free and an error milestone result during executing one or more modules of the software application.

15. The client computing system of claim 10 wherein the signaling automaton is defined by script code including data relating to the at least one expected result parameter and the threshold condition.

16. The client computing system of claim 15 wherein the specification further incudes identification of at least one recipient communication device, the script code further includes data pertaining to the at least one recipient communication device, and further comprising signaling to the at least one recipient communication device.

17. The client computing system of claim 10 wherein the signal comprises at least one of an email communication and a text message communication.

18. A non-transitory computer readable medium storing instructions executable in a processor of a computing device to:
transmit, to a memory of a server computing device, a specification identifying a software application in conjunction with at least one expected result parameter and a threshold condition for the at least one expected result parameter, the at least one expected result parameter pertaining to execution of the software application in the processor of the computing device;
receive, in the processor of the computing device, a signaling automaton generated by the server computing device, the signaling automaton based at least partly on the at least one expected result parameter and the threshold condition;
during concurrent execution, in the processor of the computing device, of object code of the software application in conjunction with the signaling automaton, monitor, by the signaling automaton, the at least one expected result parameter relative to the threshold condition; and
signal, to at least one recipient communication device, by the signaling automaton during the concurrent execution, that the at least one expected result parameter is one of lower and higher in value than the threshold condition.

19. The non-transitory computer readable medium of claim 18 wherein the signaling automaton is defined by script code including data relating to the at least one expected result parameter and the threshold condition.

20. The non-transitory computer readable medium of claim 18 wherein the signal comprises at least one of an email communication and a text message communication.
